(19) United States
(12) Patent Application Publication
(10) Pub. No.: US 2005/0078962 A1
(43) Pub. Date: Apr. 14, 2005

(54) Offset signal launch in optical fiber

(76) Inventors: Rudolf Hofmeister, Escondido, CA (US); Lewis B. Aronson, Los Altos, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/926,423

(22) Filed: Aug. 25, 2004

Related U.S. Application Data
(60) Provisional application No. 60/497,827, filed on Aug. 26, 2003.

(51) Int. Cl. H04B 10/00

(52) U.S. Cl. 398/135

(57) ABSTRACT

An optical transceiver, and related methods, are disclosed. One example of the optical transceiver includes a VCSEL that is optically coupled with a launch element configured and arranged to pass an optical signal, generated by the VCSEL, to an optical transmission medium, such as a legacy system optical fiber. In particular, the launch element implements offset launching of the optical signal from the VCSEL into a predefined launch zone of the optical transmission medium. In this way, the effective bandwidth of the optical transmission medium is increased, and modal dispersion reduced.

### RELATED APPLICATION

This application claims the benefit of United States Provisional Patent Application Ser. No. 60/497,827, entitled OFFSET SIGNAL LAUNCH IN OPTICAL FIBER, filed Aug. 26, 2003, and incorporated herein in its entirety by this reference.

### BACKGROUND OF THE INVENTION

1. Field of the Invention

The present invention relates generally to optical data transmission systems, methods and devices. More particularly, embodiments of the present invention are concerned with systems, methods and devices for enhancing the performance of legacy optical systems by enabling the effective and efficient use of those systems with relatively high line rates.

2. Related Technology

Many high speed data transmission networks rely on optical transceivers and similar devices for facilitating transmission and reception of digital data in the form of optical signals. Typically, data transmission in such networks is implemented by way of an optical transmitter, such as a laser, while data reception is generally implemented by way of an optical receiver, an example of which is a photodiode.

The optical transmitter generally transmits data in a binary form using optical signals. In particular, the optical transmitter is configured to transmit at a relatively higher optical power that represents a binary “1,” and is likewise configured to transmit at a relatively lower optical power that represents a binary “0.” The communication of this binary data from one system, location or device to another is enabled by optical transmission media, specifically, optical fibers, that connect sending and receiving devices with each other.

The characteristics of optical transmission media employed in a particular situation are a function of factors such as transmission distances and line rates. For example, single mode fibers (“SMF”), typically having core diameters of about 9 microns, are widely employed in long-haul, high speed telecommunication applications, for example, due to their relatively high bandwidth and low attenuation characteristics. Consistent with the demand for fiber optic networks of different configurations and capabilities, networks and devices based on multi-mode optic transmission media have been developed and installed as well. Exemplary core diameters for multimode fibers (“MMF”) fall within a range of about 50 microns to about 62 microns.

A variety of considerations and constraints inform the design, testing and installation of fiber optic networks. One such consideration is the effect that network segment length has on data integrity and other aspects of optical data transmission. As a general rule, a relative increase in transmission medium segment length corresponds to an increased likelihood of problems and faults concerning the optical signals transmitted through that segment. Further, the maximum permissible segment length in a particular application has an inverse relationship with the intended line rate such that, in general, as line rate increases, the corresponding maximum permissible segment length decreases. As discussed below, this relationship has certain implications with respect to the implementation and use of various types of fiber optic systems and transmission media.

In particular, the relationship between segment length, and an optical signal that implies a particular data rate, is sometimes expressed in terms of the probability that the optical signal will pass through the segment without being materially impaired. Typically, the extent to which such a signal is impaired, if at all, is determined with reference to various established standards, requirements or protocols such as the Gigabit Ethernet, Fibre Channel and Synchronous Optical Network (“SONET”) protocols for example.

To assess the probability of signal impairment with respect to a particular segment or type of segment, an optical signal, or string of bits, of known parameters is passed through “n” segments, or test fibers. After transmission through each of the various segments, the received signal is evaluated to determine whether any impairment has occurred. Exemplarily, this evaluation process consists of comparing various aspects of the received signal with corresponding aspects of the transmitted signal.

After the transmission of the optical signal has been performed for each of a statistically significant population “n” of fiber segments, a determination of the probability of the occurrence of a signal impairment can then be made. For example, an evaluation process such as that just described might result in a finding that for a 300 meter segment, there is a 99% probability that an optical signal representing a 10 Gbps line rate will be unimpaired after transiting the segment.

As the foregoing suggests, the particular line rate, probability, and permissible segment length associated with a given situation will vary depending upon factors such as whether the particular fiber is an SMF or MMF, as well as the relative age of the particular fiber employed. For example, more recent MMF fibers have better performance characteristics than earlier generations of MMF fibers.

It was noted elsewhere herein that many of the early fiber optic system installations employed MMF due to the desirable performance characteristics of that type of fiber. However, as user needs continued to develop and technological advances were made, single mode fiber (“SMF”) installations became increasingly common as well. The popularity of SMFs has been due at least in part to the fact that SMF-based systems are well suited to scale up to accommodate ever-increasing line rates, without necessitating significant infrastructure changes. Thus, a user with an SMF system can readily implement line rate changes at minimal expense.

In contrast however, the scalability of MMFs is rather limited. This is particularly true with respect to the legacy fiber optic systems that incorporate early generations of MMFs. While many of such legacy systems can support segment lengths up to 300 meters, there are practical limits to the data rates that can be usefully accommodated in such segment lengths, as discussed above. For example, at line rates of 10 Gb/s, such as are employed in connection with the 10 Gigabit Ethernet protocol for example, the maximum permissible segment length has dropped significantly, in some cases to as short as 30 to 80 meters.

More particularly, segment lengths of about 300 m to 600 m, depending upon the application, were established as a result of the use of relatively low data rate protocols. However, when such segment lengths are employed in connection with higher rates, such as 10 Gb/s for example, the minimum guaranteed segment length is reduced significantly, in some cases to only about 30 m to 80 m. In light of the fact that, as noted above, existing segment lengths may reach 600 m, minimum guaranteed segment lengths of 30 m to 80 m are clearly inadequate.

Thus, owners and operators of legacy systems who wish to take advantage of higher line rates are often compelled to choose between upgrading/modifying the legacy MMF system, or simply installing a new system that is suited for use with the higher line rates. Modification of legacy MMF systems, such as by reductions in the length of transmission media segments, is often not a practical alternative since those segments typically have a fixed length that is dictated by the distance between existing equipment racks. Moreover, such modification would be difficult in any event since the transmission fibers are typically installed in locations, such as underground or in floors or walls, where they are not readily accessible. Where such modifications are undertaken, they typically involve significant effort and cost, and generally require that some or all of the system be taken off line until such time as the upgrade can be completed.

The alternative to upgrading and/or modifying a legacy MMF system is to simply replace the MMF system with a new fiber installation. However, this option is not a practical alternative in many cases since the significant capital expenditures associated with new installations are often prohibitive. Usually, only relatively large operators can afford to make the investment necessary for a new installation.

Notwithstanding the foregoing problems and concerns, at least some legacy fiber and related systems often have at least some inherent capacity to transmit data at relatively higher rates, although known systems, methods and devices have not effectively employed or exploited that capacity. More particularly, the parabolic index of refraction profile or, simply, “parabolic index profile,” that characterizes many legacy MMF fibers means that such fibers typically have a relatively higher bandwidth at, for example, 1310 nm. These, and other, types of fiber are often configured with parabolic index profiles so as to avoid the optical dispersion that typically attends step index profiles.

In recognition of problems and concerns such as are exemplified by the foregoing, some attempts have been made to improve the performance and results obtained in connection with the use of legacy fiber systems. As outlined below however, such attempts have thus far suffered from various shortcomings that significantly impair their effectiveness and usefulness.

For example, one attempt at a solution to some of the problems posed by legacy fiber systems relates to a module that incorporates a specially manufactured fiber pigtail having an offset, or eccentric, core. The eccentric core pigtail is arranged to receive optical signals from a transmitter of the module and to launch those signals into an offset launch zone of fiber with which the module is coupled, specifically, an MMF having a concentric core configuration. One problem with approaches such as this however is that the module relies on non-standard components, namely, the eccentric core pigtail, for its functionality. Further, specialized manufacturing techniques are required to produce this pigtail and thereby contribute to relative increases in the overall cost and complexity of the module.

Another concern with this type of approach to offset launching of optical signals relates to the line rates that can be achieved with such modules. In particular, it is not clear that modules and devices implementing this approach can be effective for data rates exceeding about 1.0 Gb/s. With regard to data rates, at least, various other attempts at a solution to problems posed by legacy fiber systems are similarly deficient. Further, transmitters and modules that purport to implement useful functionality in connection with legacy fiber systems are limited not only in terms of effective data rates, but also have certain hardware limitations as well. For example, some of such transmitters and modules are limited to use with particular types of optical transmitters. This lack of flexibility impairs the usefulness of these devices and is particularly problematic in light of the rapid pace of advancements in the field of optical data transmission technology.

In view of the foregoing, and other, problems in the art, it would be useful to provide optical systems, methods and devices that would enable the employment of legacy systems with systems and applications that require relatively high line rates, such as, for example, the 10 Gbps rate employed in connection with Gigabit Ethernet and other protocols. Further, such optical systems, methods and devices should be relatively easy to manufacture and install. Finally, these optical systems, methods and devices should be relatively inexpensive.

### BRIEF SUMMARY OF AN EXEMPLARY EMBODIMENT OF THE INVENTION

In general, embodiments of the invention are concerned with optical systems, methods and devices that enhance the performance of legacy optical systems by enabling the effective and efficient use of those systems with relatively high line rates.

In one exemplary embodiment of the invention, an optical transceiver is provided that includes a 1310 nm vertical cavity surface emitting laser (“VCSEL”). The optical transceiver further includes a launch element, such as a fiber stub, lens, or other suitable optical device(s), configured and arranged to pass an optical signal generated by the VCSEL. The launch element is also configured and arranged to implement launching of the optical signal from the VCSEL into an optical transmission fiber, such as a graded index MMF for example.

More particularly, the launch element of the optical transceiver directs the VCSEL output into a predetermined off-center region of an optical fiber, or transmission fiber, with which the optical transceiver communicates. Among other things then, embodiments of the launch element enable achievement of a mode conditioning effect where only selected modes in the transmission fiber are excited, so that efficient use is made of the high bandwidth portion of the transmission fiber. Moreover, modal dispersion of the transmitted optical signal is reduced, and bandwidth of the legacy transmission fiber further enhanced, since the transmitted signal largely avoids the outer edges and the central defect of the transmission fiber.

### BRIEF DESCRIPTION OF THE DRAWINGS

In order that the manner in which the above-recited and other aspects of the invention are obtained, a more particular description of the invention briefly described above will be rendered by reference to specific embodiments thereof which are illustrated in the appended drawings. Understanding that these drawings depict only exemplary embodiments of the invention and are not therefore to be considered limiting of its scope, the invention will be described and explained with additional specificity and detail through the use of the accompanying drawings in which:

FIG. 1 is a simplified block diagram illustrating aspects of the relation between an exemplary optical transceiver that includes a transmitter and associated launch element, and optical transmission fibers;

FIG. 2 is a diagram illustrating an exemplary offset arrangement of a launch element relative to an associated optical transmission fiber;

FIG. 3 is a diagram illustrating, in a section view, the configuration and arrangement of an exemplary predefined “launch zone” of one optical transmission fiber in connection with which embodiments of the invention may be employed; and

FIG. 4 is a flow diagram illustrating exemplary aspects of a method for offset launch of an optical signal.

### DETAILED DESCRIPTION OF EXEMPLARY EMBODIMENTS OF THE INVENTION

### I. General Characteristics of Exemplary Operating Environments

In general, exemplary embodiments of the invention are concerned with systems, methods and devices configured to enable the effective, efficient and reliable use of legacy fiber optic systems with relatively high line rates, without requiring significant infrastructure modifications.

Embodiments of the invention are suitable for use in connection with a variety of line rates and may be used in systems corresponding to various protocols and operating at various associated line rates. Exemplary protocols in connection with which embodiments of the invention can be employed include, but are not limited to, Ethernet, Fast Ethernet, Gigabit Ethernet, 10 Gigabit (“XGig”) Ethernet, Fibre Channel (“FC”), and Synchronous Optical Network (“SONET”). Similarly, embodiments of the invention may be employed in connection with various types of optical transmission media, examples of which include, but are not limited to, single mode fibers (“SMF”) and multi-mode fibers (“MMF”), and extend to both graded index (“GRIN”) and step index fibers.

Finally, a further aspect of exemplary implementations of the invention is that they are suited for use with a variety of optical devices, such as transceivers, transmitters, and transmitter optical subassemblies (“TOSA”). The transmitters employed in such devices include, but are not limited to, vertical cavity surface emitting lasers (“VCSEL”), distributed feedback (“DFB”) lasers, and Fabry-Perot (“FP”) lasers, that transmit 850 or 1310 nanometer (“nm”) light. Similarly, embodiments of the invention may be employed in connection with a variety of optical receiver types.

It should be noted that the foregoing operating environments and associated systems, protocols, and devices, are exemplary only. Accordingly, the foregoing description of such environments, systems, protocols and devices is not intended to limit the scope of the invention in any way. More generally, embodiments of the invention may be employed in connection with any system, device or protocol where it would be desirable to implement the functionality disclosed herein.

### II. Aspects of an Exemplary Optical Transceiver

A variety of devices, systems and methods may be employed to implement the functionality disclosed herein. In general, such functionality is concerned with directing an optical data signal into a predetermined region of an optical fiber, where the predetermined region, exemplarily, is characterized by a transmission bandwidth capability that is relatively higher than that of other portions of the optical fiber.

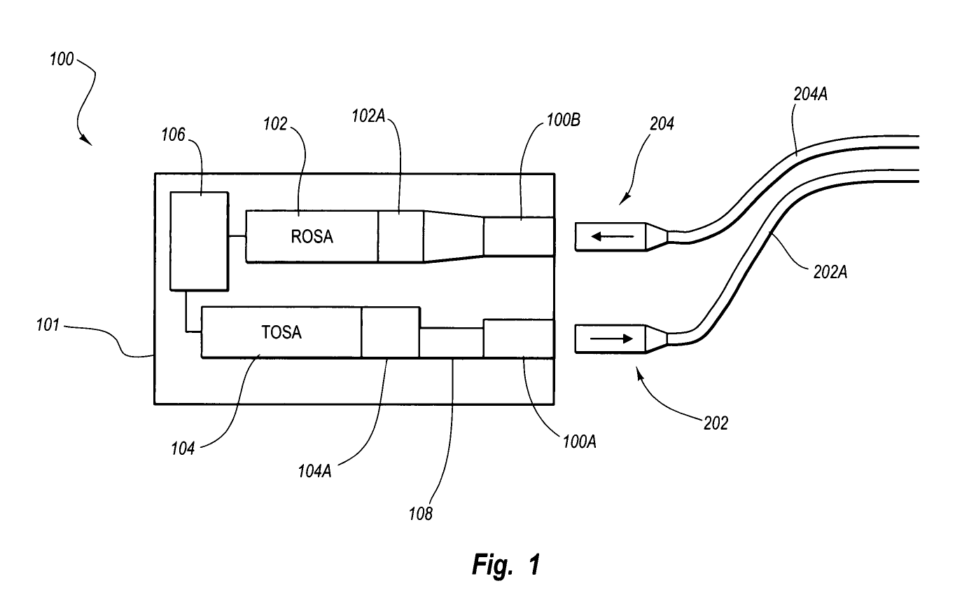

At least some embodiments of the invention are concerned with an optical transceiver configured to implement offset launching of optical signals into an optical transmission fiber. Directing attention now to FIG. 1, details are provided concerning a schematic depiction of example of one such optical transceiver, denoted generally at 100.

In the illustrated embodiment, the optical transceiver 100 includes a pair of optical connector receptacles 100A and 100B configured to removably receive corresponding optical connectors 202 and 204, attached to corresponding optical fibers 202A and 204A, respectively. In this way, optical signals can be transmitted by the optical transceiver 100 onto optical fiber 202A when optical connector 202 is received in optical connector receptacle 100A, and optical signals can be received by the optical transceiver 100 from optical fiber 204A when optical connector 204 is received in optical connector receptacle 100B.

In at least some cases, the optical connectors 202 and 204, as well as various other elements associated with, or included in, the optical transceiver 100 conform with a particular form factor, as specified by an MSA or protocol. Accordingly, the scope of the invention is not limited to any particular physical configuration of the optical transceiver 100, nor of components associated with the optical transceiver 100.

The exemplary optical transceiver 100 of FIG. 1 further includes a housing 101 within which are substantially disposed various components which enable implementation of the aforementioned optical transmission and reception functions. In particular, the optical transceiver 100 includes a ‘receive’ optical subassembly (“ROSA”) 102 that is configured to communicate with optical connector 204, and a ‘transmit’ optical subassembly (“TOSA”) 104 configured to communicate with optical connector 202. The exemplary ROSA 102 and TOSA 104 may be configured for conformance with any of a variety of different protocols and line rates. In one exemplary implementation, the ROSA 102 and TOSA 104 are able to support line rates at least as high as 10 Gb/s, but alternative embodiments of the optical transceiver 100 can accommodate other line rates.

With particular reference to the illustrated embodiment, the ROSA 102 includes a detector 102A, such as a photodiode for example, that receives high speed optical data signals and converts the received optical data signals to electrical data signals. On the other hand, the TOSA 104 includes a transmitter 104A that receives high speed electrical data signals and converts the received electrical data signals to optical data signals for transmission onto a network or other system.

As disclosed elsewhere herein, various types of transmitters 104A may be employed in connection with embodiments of the invention. Examples of such transmitters 104A include, but are not limited to, VCSELs, DFB lasers, and FP lasers. Transmitters capable of transmitting at 1310 nm are particularly useful in some applications, but the scope of the invention is not so limited, and various other transmitters, such as 850 nm transmitters for example, can alternatively be employed.

In addition to the aforementioned components, exemplary embodiments of the optical transceiver 100 include various other components (not shown), some or all of which may be embodied as circuitry 106, that contribute to the high speed reception and transmission, respectively, of optical and electrical signals, as well as the processing of such signals. Such components include, but are not limited to, a post-amplifier, a laser driver, transimpedance amplifier (“TIA”), and monitor photodiode (“MPD”), to name a few. The circuitry 106 may take the form of integrated circuits (“IC”) or any other suitable form.

With continuing reference to FIG. 1, the optical transceiver 100 further includes a launch element 108 interposed between the transmitter 104A of the TOSA 104 and the optical fiber connectors 100A. Note that some exemplary implementations of the launch element may be referred to in the disclosure as a “transmit SMF,” and some exemplary implementations of the optical fiber into which the optical signal is launched by the launch element may be referred to in the disclosure as a “receive” fiber. In general, the launch element 108 is arranged so that the optical signals transmitted by the transmitter 104A pass through the launch element 108 and then into the optical fiber 202A carried by the connector 202.

While further details concerning the optical effects implemented by the launch element 108 with respect to the optical signals transmitted by the transmitter 104A are disclosed in further detail elsewhere herein, the launch element 108 generally serves to facilitate the direction of optical signals from the transmitter 104A into a desired portion, or region, of the optical fiber 202A. More particularly, the launch element 108 serves to direct signals from the transmitter 104A into a predetermined off-center region of an optical fiber, such as optical fiber 202A, with which the optical transceiver 100 is optically coupled.

The launch element 108 may be implemented in various forms. Thus, the embodiments of the launch element 108 disclosed herein simply comprise exemplary structural implementations of a means for offset launching of an optical signal. The scope of the invention is not limited to these exemplary structural implementations however and, rather, extends to any other structures of comparable functionality.

Finally, exemplary embodiments of the optical transceiver 100 may include various other optical components as well so that various optical, and other, effects can be achieved with respect to transmitted and/or received optical signals. Such optical components include, but are not limited to, reflectors, refractors, collimating lenses, and focusing lenses.

### III. Aspects of Exemplary Launch Elements and Transmission Fiber

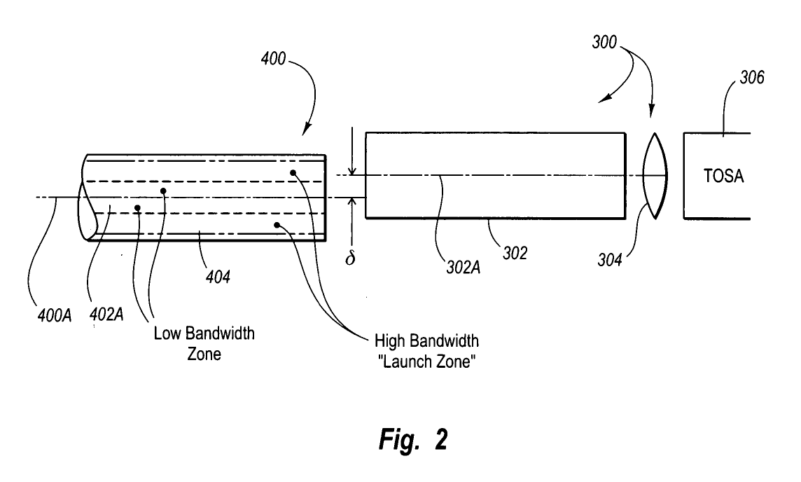

It was noted earlier that embodiments of the launch element may be implemented in a variety of different ways. With attention now to FIG. 2, details are provided concerning exemplary embodiments of a launch element 300, as employed in connection with a transmission medium 400 held, for example, in an optical connector (see, e.g., FIG. 1). Exemplary embodiments of the launch element 300 can support data rates of at least about 10 Gb/s and are compatible with a variety of different transmitters, as noted in connection with the discussion of FIG. 1.

As suggested in FIG. 2 and discussed above in connection with FIG. 1, exemplary embodiments of the launch element 300 may take various forms and include any number of components, examples of which include a fiber stub 302 and/or lens(es) 304, and/or other optical components. Some or all of the components of the launch element 300 may be discrete optical components that are optically coupled with the TOSA 306 or other transmitting device.

Alternatively, some or all of the components of the launch element 300 may comprise elements of one or more of a TOSA 306, optical transmitter, or optical transceiver. With regard to arrangements where the launch element is included as an element of an optical transceiver, it should be noted that because the offset launching of optical signals is afforded by the configuration and arrangement of the launch element 300 within the optical transceiver itself, no special optical connectors are required to connect to the optical transceiver.

In the illustrated arrangement of the launch element 300 and transmission medium 400, the fiber stub 302 of the launch element 300 is exemplarily implemented as an SMF stub having a longitudinal axis 302A that is offset a predetermined distance δ from a longitudinal axis 400A defined by the transmission medium 400 into which optical signals are to be launched. Similarly, the lens 304 in the illustrated embodiment lies along axis 302A as well. However, the illustrated arrangement of the launch element 300 and transmission medium 400 is exemplary only. For example, the axes 302A and 400A may be substantially parallel with each other, or may be non-parallel with respect to each other.

For example, in alternative embodiments, there is no need to offset respective axes of the launch element 300 and transmission medium 400 in order to achieve offset launching of optical signals, discussed below. Rather, in such alternative embodiments, optical devices such as lenses, reflectors and/or refractors can be used in various combinations and/or orientations to achieve the same offset launch effects associated with the exemplary arrangement illustrated in FIG. 2. Thus, the scope of the invention should not be construed to be limited to the exemplary arrangement disclosed in FIG. 2.

With continuing reference to FIG. 2, the transmission medium 400 into which optical signals are directed by the launch element 300 may take various forms. For example, in some implementations, the transmission medium 400, which may also be referred to in this disclosure as a “receive” fiber, comprises one such as is typically employed in connection with a legacy fiber optic data transmission and communication system, such as an MMF. In one specific implementation, the transmission medium 400 with which the launch element 300 communicates takes the form of a 62.5/125-μm MMF with a parabolic graded index profile. However, embodiments of the launch element 300 and related components, such as the optical transceiver, are not limited for use with any particular transmission medium.

It was noted earlier that in some exemplary embodiments, the longitudinal axis 400A defined by the transmission medium 400 is offset from the longitudinal axis 302A of the fiber stub 302 by a predetermined distance δ. In general, and as disclosed in further detail elsewhere herein, this arrangement enables the optical signals to be launched from the launch element 300 through a predetermined off-center zone of the transmission medium 400, rather than through a central portion of the transmission medium 400.

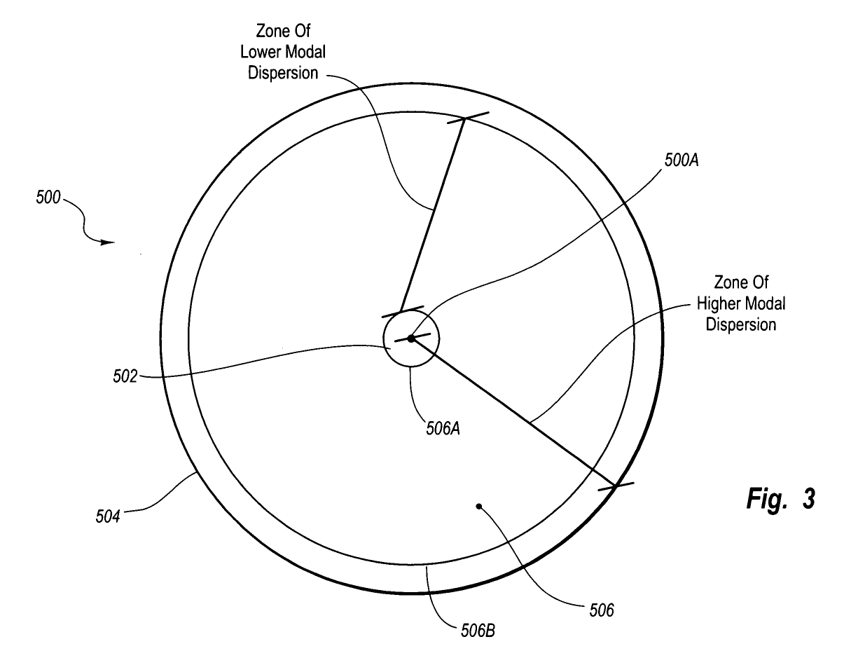

More particularly, and as indicated in FIG. 2, some implementations of the transmission medium 400 include a relatively low bandwidth transmission zone 402 near the center of the transmission medium 400, and a relatively high bandwidth transmission zone 404 interposed between the center, or central portion, and the perimeter of the transmission medium 400. Note that the cladding of the transmission medium 400 is not shown, for purposes of clarity. Further details concerning particular aspects of the aforementioned zones and related signal launch processes are provided below in connection with the discussion of FIG. 3.

### IV. Aspects of an Exemplary Transmission Fiber

Directing attention now to FIG. 3, and with continuing attention to FIG. 2, further details are provided concerning aspects of an exemplary transmission medium in connection with which embodiments of the invention may be employed. The transmission medium is denoted generally at 500 in FIG. 3 and defines a longitudinal axis 500A. In general, the transmission medium 500 is implemented as a fiber that is able to pass optical signals. The transmission medium 500 may comprise plastic, glass, silicon, or any other suitable material(s) compatible with the functionality disclosed herein. Some embodiments of the invention are well suited for use in connection with transmission media comprising MMFs with a core diameter falling within a range of about 50μ to about 62μ, but the scope of the invention is not limited to such media.

With more particular attention to FIG. 3, the exemplary transmission medium 500 takes the form of a so-called legacy fiber, such as an MMF having a core diameter falling within a range of about 50μ to about 62μ. Exemplarily, the transmission medium 500 is a graded index fiber, constructed so that light rays traveling near the inner portion 502 of the transmission medium 500 have a relatively lower average velocity than light rays traveling near the outer portion 504 of the transmission medium. This difference in velocity is due to the fact that rays near the perimeter of the transmission medium travel a relatively greater distance than rays nearer the center of the transmission medium and, accordingly, the rays traveling the relatively greater distance must travel at a higher speed in order to remain synchronized with the rays that travel a relatively shorter distance. However, this synchronization is impaired in the central defect region near the center of the fiber.

Because the average velocity of light rays near the outer portion 504 is greater, relatively speaking, than the average velocity of light rays near the inner portion 502, the overall modal dispersion resulting from the difference in the velocities is relatively great in the area or zone delimited by the inner portion 502 and the outer portion 504. This notion is denoted in FIG. 3 by the exemplary transmission medium 500 cross-sections denoted, respectively, “Zone of Higher Modal Dispersion” and “Zone of Lower Modal Dispersion.” It should be noted that the aforementioned, and other, zones indicated in the figures and discussed herein are for illustration purposes and are not intended to limit the scope of the invention in any way.

Thus, the total or overall modal dispersion experienced in connection with the transmission medium 500 can be reduced by restricting the portion of the transmission medium 500 into which optical signals are launched. More particularly, an exemplary launch zone 506 is defined that includes, or embraces, some predetermined portion less than the total portion of the transmission medium 500 that is able to receive and pass optical signals. In general, launch zones can be defined, for example, using empirical and/or computational methods and processes.

In the illustrated exemplary embodiment, the launch zone 506 has inner and outer boundaries 506A and 506B located such that the overall modal dispersion resulting from the difference in light ray velocities within the launch zone 506 is relatively smaller than the overall modal dispersion resulting from the difference in light ray velocities in an area bounded by the longitudinal axis 500A and the outer portion 504. Thus, one result of the configuration of the launch zone 506 in FIG. 3 is that optical signals directed into the launch zone 506 enter the transmission medium 500 in an off-center orientation, relative to the longitudinal axis 500A of the transmission medium 500. Such off-center launching of the optical signal may also be referred to herein as “offset launching” of an optical signal.

By restricting the portion of the transmission medium 500 into which optical signals are launched, modal dispersion is controlled, and the effective bandwidth of the transmission medium 500 is increased. More particularly, transmission of an optical data signal through the launch zone 506 results in achievement of relatively higher data rates through the transmission medium 500 than could otherwise be obtained with such fibers. This is particularly true with legacy MMFs. In some exemplary cases, the effective bandwidth is increased to the extent that legacy MMFs are able to support line rates as high as 10 Gb/s, notwithstanding legacy fiber segment lengths that ordinarily would restrict line rates to much lower values.

Thus, an XGig optical transceiver that includes a launch element, such as the exemplary optical transceivers disclosed herein, can be readily employed in connection with legacy MMFs to achieve the relatively high line rates required by more recent systems, devices and protocols. It should be noted here that the fact that many legacy fibers are compatible with single mode output means that transmission into the legacy fiber can be accomplished in various modes including, but not limited to, a helical mode and an offset mode.

As the foregoing suggests, aspects of the definition of the launch zone 506, such as the configuration and orientation of the launch zone 506, can be tailored to suit, for example, the requirements of a particular application, transmission medium 500, or transmitter. In the illustrated embodiment for example, the launch zone 506 is generally donut-shaped and is centered about the longitudinal axis 500A of the transmission medium 500. As a consequence of the donut shape, a certain predetermined portion of the transmission medium 500 near the longitudinal axis 500A is excluded from the launch zone 506. Likewise, a predetermined portion of the transmission medium 500 at the outer portion 504 is excluded from the launch zone 506 as well. Of course, other launch zone configurations and orientations may be employed as well, and the scope of the invention is not limited to those disclosed herein.

### V. Operational Aspects of Exemplary Implementations of the Invention

As indicated above, one aspect of exemplary embodiments of the invention is that an optical data signal is launched into a predetermined portion of an optical transmission fiber that is offset some predetermined distance from the longitudinal axis, or center, of that optical transmission fiber (see FIGS. 1 through 3). This result can be achieved in various ways such as, for example, by introducing an offset between the longitudinal axis of a launch element from which the optical signal is transmitted and the longitudinal axis of the fiber that receives the launched signal. Operationally, these, and equivalent, arrangements produce various useful results.

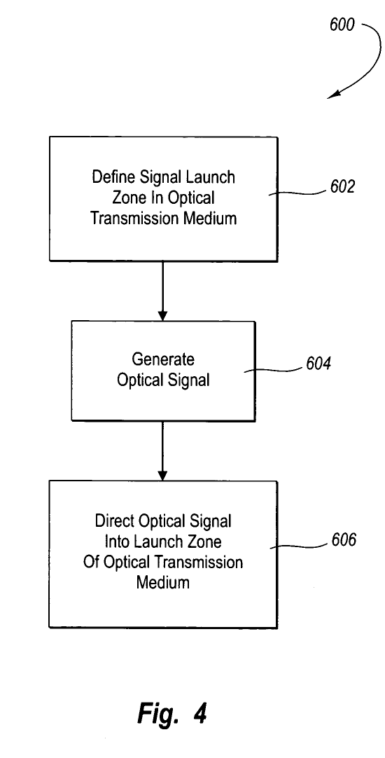

With reference now to FIG. 4, details are provided concerning a process 600 for offset launching of an optical signal. At least some exemplary implementations of the process 600 are performed in connection with an optical transceiver and MMF transmission medium. The scope of the invention is not so limited however.

At stage 602 of the process, a launch zone is defined in a fiber optic transmission medium. Generally, the exemplary launch zone excludes a predefined central portion of the transmission media and corresponds to an area of relatively higher bandwidth of the transmission medium, so that the transmission medium is able to accommodate relatively higher data rates than would ordinarily be possible. The definition of the launch zone can be informed by a variety of factors and considerations such as, but not limited to, the desired line rate to be transmitted through fiber optic transmission medium, the physical configuration and specifications of the transmission medium, and the segment lengths of the system in connection with which the signal is to be transmitted. After the launch zone is defined, the process 600 advances to stage 604 where an optical data signal is generated, such as by an FP laser, DFB laser, or VCSEL for example.

The optical signal is then launched, at stage 606, into the launch zone of the fiber optic transmission medium. Because the exemplary launch zone that was defined does not include a predefined central portion of the transmission medium, the signal is launched into an area of the transmission medium outside of, or offset from, that central portion.

In some instances, line rates as high as 10 Gbps or higher, can be achieved with processes such as process 600, with probabilities as high as about 90% to about 95%, notwithstanding that the legacy system into which the optical signal is launched may have segment lengths up to 300 meters long, or longer. Thus, one aspect of exemplary implementations of the invention is that they are able to overcome the undesirable effects that would ordinarily be associated with attempts to transmit at relatively high line rates over legacy fibers.

Another useful aspect of offset optical signal launching relates to manufacturing defects resulting from the processes that were typically employed to produce the legacy fiber. In particular, the offset signal launch functionality implemented by embodiments of the invention allows the optical signal to be transmitted into the legacy fiber, but away from the area where the central defect, if present, is most likely to be encountered. This is a desirable result since the central defect of the transmission medium would otherwise tend to cause dispersion and other negative effects in the transmitted signal. Such central defects are commonly encountered, for example, in fibers comprising germanium-doped silicon dioxide.

The disclosed embodiments are to be considered in all respects only as exemplary and not restrictive. The scope of the invention is, therefore, indicated by the appended Claims rather than by the foregoing disclosure. All changes which come within the meaning and range of equivalency of the Claims are to be embraced within their scope.

1. An optical transceiver comprising:
a housing;
a transmit optical subassembly substantially disposed within the housing and including a transmitter;
a receive optical subassembly substantially disposed within the housing, the receive and transmit optical subassemblies supporting line rates at least as high as about 10 Gb/s;
electronic circuitry substantially disposed within the housing and in communication with at least one of: the transmit optical subassembly and the receive optical subassembly; and
means for offset launching of an optical signal generated by the transmitter.

2. The optical transceiver as recited in claim 1, wherein the transmitter comprises one of: a VCSEL; a DFB laser; and, an FP laser.

3. The optical transceiver as recited in claim 1, wherein the transmitter is configured to transmit one of: 1310 nm light; and 850 nm light.

4. The optical transceiver as recited in claim 1, wherein the means for offset launching facilitates achievement of about a 10 Gb/s data rate with a probability of at least about 90 percent when the optical transceiver is employed in conjunction with MMF segments of about 300 meters or greater in length.

5. The optical transceiver as recited in claim 1, wherein the means for offset launching of an optical signal directs an optical signal generated by the transmitter into a predefined launch zone of an optical transmission medium when the optical transceiver is employed in connection with the optical transmission medium.

6. The optical transceiver as recited in claim 5, wherein the predefined launch zone comprises some predetermined portion of the optical transmission medium that is less than a total portion of the optical transmission medium that is able to receive and pass optical signals.

7. The optical transceiver as recited in claim 5, wherein the predefined launch zone has a configuration that is at least roughly donut-shaped.

8. The optical transceiver as recited in claim 1, wherein the means for offset launching of an optical signal facilitates control of modal dispersion in an optical transmission medium when the optical transceiver is employed in connection with the optical transmission medium.

9. The optical transceiver as recited in claim 1, wherein the means for offset launching of an optical signal facilitates enhancement of the effective bandwidth of an optical transmission medium when the optical transceiver is employed in connection with the optical transmission medium.

10. The optical transceiver as recited in claim 1, wherein the means for offset launching of an optical signal facilitates line rates at least as high as about 10 gigabits/second in an MMF when the optical transceiver is employed in connection with the MMF.

11. The optical transceiver as recited in claim 10, wherein the MMF has a core diameter of one of: about 50 microns; and, about 62 microns.

12. The optical transceiver as recited in claim 1, wherein the means for offset launching of an optical signal has a single mode output.

13. The optical transceiver as recited in claim 1, wherein the means for offset launching of an optical signal excites only selected modes in an optical transmission medium when the optical transceiver is employed in connection with the optical transmission medium.

14. The optical transceiver as recited in claim 1, wherein the optical transceiver is MSA-compliant.

15. An optical transceiver comprising:
a housing;
a transmit optical subassembly substantially disposed within the housing and including a DFB laser;
a receive optical subassembly substantially disposed within the housing;
electronic circuitry substantially disposed within the housing and in communication with at least one of: the transmit optical subassembly and the receive optical subassembly; and
a launch element optically coupled with the DFB laser and configured and arranged to direct an optical signal generated by the DFB laser into a predefined launch zone of an optical transmission medium when the optical transceiver is employed in connection with the optical transmission medium.

16. The optical transceiver as recited in claim 15, wherein the DFB laser operates at a wavelength of about: 850 nm; or, 1310 nm.

17. The optical transceiver as recited in claim 15, wherein the transmit optical subassembly and receive optical subassembly support line rates at least as high as about 10 Gb/s.

18. The optical transceiver as recited in claim 15, wherein the launch element comprises a fiber stub.

19. The optical transceiver as recited in claim 18, wherein the fiber stub comprises an SMF fiber stub.

20. The optical transceiver as recited in claim 18, wherein the fiber stub comprises a core and cladding that are substantially concentric with each other.

21. The optical transceiver as recited in claim 15, wherein the launch element is arranged in the optical transceiver such that a longitudinal axis of the launch element is offset a predetermined distance from a longitudinal axis of the optical transmission medium when the optical transceiver is optically coupled with the optical transmission medium.

22. The optical transceiver as recited in claim 15, wherein the launch element comprises at least one of: at least one lens; and, at least one reflector.

23. The optical transceiver as recited in claim 15, wherein the predefined launch zone of the optical transmission medium comprises some predetermined portion of the optical transmission medium that is less than a total portion of the optical transmission medium that is able to receive and pass optical signals.

24. The optical transceiver as recited in claim 15, wherein the predefined launch zone of the optical transmission medium has a configuration that is at least roughly donut-shaped.

25. The optical transceiver as recited in claim 15, wherein the optical transceiver is configured to operate in connection with MMF optical transmission media.

26. The optical transceiver as recited in claim 15, wherein the launch element facilitates line rates at least as high as about 10 gigabits/second in an MMF when the optical transceiver is employed in connection with the MMF.

27. The optical transceiver as recited in claim 15, wherein the launch element facilitates achievement of about a 10 Gb/s data rate with a probability of at least about 90 percent when the optical transceiver is employed in conjunction with MMF segments of about 300 meters or greater in length.

28. A method for launching of optical signals, the method being performed in connection with an optical transceiver and comprising:
generating an optical data signal having an associated line rate of about 10 Gb/s;
transmitting the optical data signal; and
offset launching the optical data signal into an optical transmission medium.

29. The method as recited in claim 28, wherein the transmitted optical signal has about a wavelength of about 1310 nm.

30. The method as recited in claim 28, wherein offset launching of the optical data signal facilitates control of modal dispersion in the optical transmission medium.

31. The method as recited in claim 28, wherein offset launching of the optical data signal contributes to enhancement of the effective bandwidth of the optical transmission medium.

32. The method as recited in claim 28, wherein offset launching of the optical data signal excites only selected modes in the optical transmission medium.

33. The method as recited in claim 28, wherein the offset launched optical signal comprises a single mode output.
